(19) United States
(12) Patent Application Publication
(10) Pub. No.: US 2024/0169273 A1
(43) Pub. Date: May 23, 2024

(54) FIELD EQUIPMENT DATA SYSTEM

(71) Applicant: Schlumberger Technology Corporation, Sugar Land, TX (US)

(72) Inventors: Garud Sridhar, Sr., London (GB); Surej Kumar Subbiah, Doha (QA); Muhammad Ibrahim, Doha (QA); Adrian Enrique Rodriguez Herrera, Gatwick (GB); Nasser Alhamad, Al Ahmadi (KW); Supriya Gupta, Houston, TX (US); Assef Mohamad Hussein, Gatwick (GB); Vigneshwaran Santhalingam, Houston, TX (US); Rajeev Ranjan Sinha, Houston, TX (US)

(21) Appl. No.: 18/552,241

(22) PCT Filed: Mar. 25, 2022
(86) PCT No.: PCT/US2022/071353

§ 371 Date: Sep. 25, 2023

Related U.S. Application Data
(60) Provisional application No. 63/200,756, filed on Mar. 26, 2021.

(51) Int. Cl. G06N 20/00

(52) U.S. Cl. CPC G06N 20/00

(57) ABSTRACT

A method can include receiving real-time, time series data from equipment at a wellsite that includes a wellbore in contact with a fluid reservoir; processing the time series data as input to a trained machine learning model to predict a future solids event related to influx of solids into the wellbore from the fluid reservoir; and outputting a time of the future solids event.

### RELATED APPLICATIONS

This application claims priority to and the benefit of a US Provisional Application having Ser. No. 63/200,756, filed 26 Mar. 2021, which is incorporated by reference herein.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations.

### SUMMARY

A method can include receiving real-time, time series data from equipment at a wellsite that includes a wellbore in contact with a fluid reservoir; processing the time series data as input to a trained machine learning model to predict a future solids event related to influx of solids into the wellbore from the fluid reservoir; and outputting a time of the future solids event. A system can include a processor; memory accessible to the processor; and processor-executable instructions stored in the memory to instruct the system to: receive real-time, time series data from equipment at a wellsite that includes a wellbore in contact with a fluid reservoir; process the time series data as input to a trained machine learning model to predict a future solids event related to influx of solids into the wellbore from the fluid reservoir; and output a time of the future solids event. One or more computer-readable storage media can include processor-executable instructions to instruct a computing system to: receive real-time, time series data from equipment at a wellsite that includes a wellbore in contact with a fluid reservoir; process the time series data as input to a trained machine learning model to predict a future solids event related to influx of solids into the wellbore from the fluid reservoir; and output a time of the future solids event. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment, an example of a network and

an example of a system;

FIG. 3 illustrates example of equipment;

FIG. 4 illustrates an example of solids production from a reservoir;

FIG. 5 illustrates an example of a system;

FIG. 6 illustrates an example of a system;

FIG. 7 illustrates examples of machine learning models;

FIG. 8 illustrates an example of a method and an example of a machine learning model;

FIG. 9 illustrates examples of time series data plots that include a solids indicator channel;

FIG. 10 illustrates examples of time series data plots that include a solids indicator channel;

FIG. 11 illustrates examples of time series data plots that include a solids indicator channel;

FIG. 12 illustrates an example of a system;

FIG. 13 illustrates an example of a method and an example of a system;

FIG. 14 illustrates examples of computer and network equipment; and

FIG. 15 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

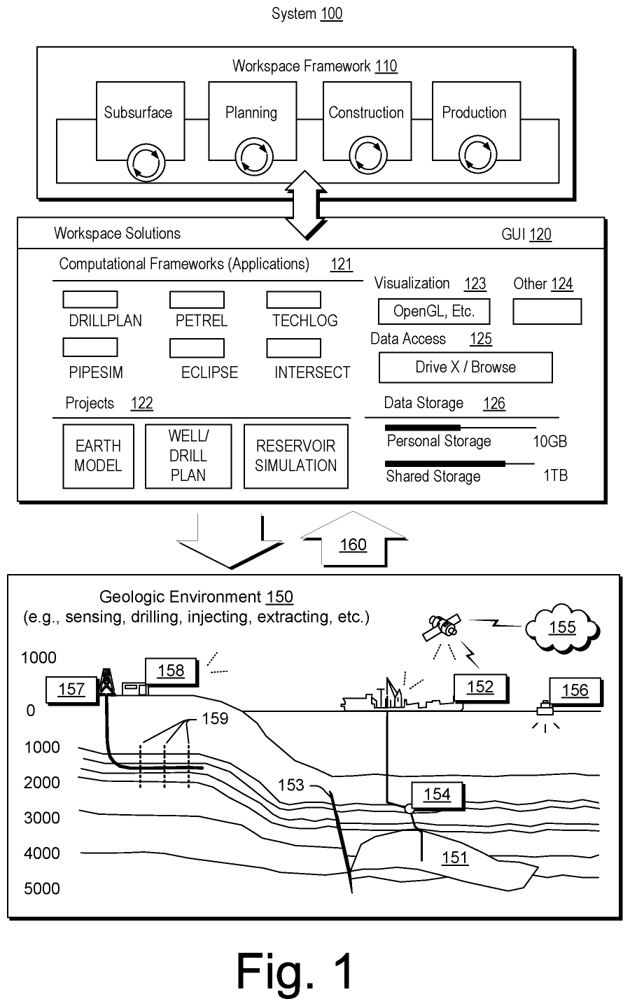

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (Schlumberger Limited, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework. As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. In such an approach, one or more features of a framework that may be available in one language may be accessed via a converter. For example, consider the APACHE SPARK framework that can include features available in a particular language where a converter may convert code in another language to that particular language such that one or more of the features can be utilized. As an example, a production field may include various types of equipment, be operable with various frameworks, etc., where one or more languages may be utilized. In such an example, a converter may provide for feature flexibility and/or compatibility.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where later acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (Schlumberger Limited, Houston Texas) or the PETROMOD simulator (Schlumberger Limited, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc. The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions. The MANGROVE simulator (Schlumberger Limited, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

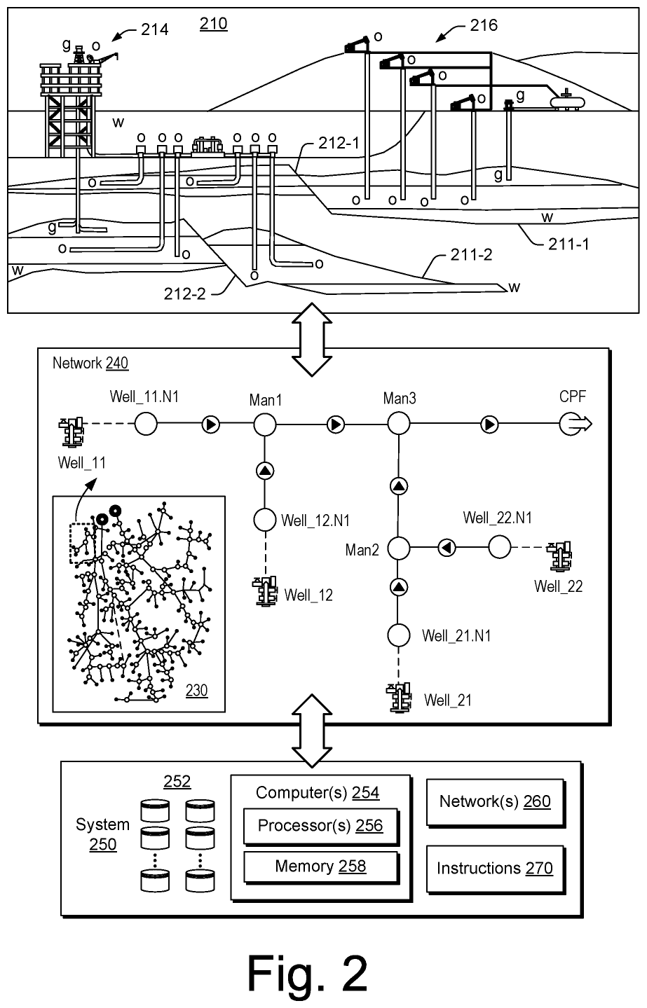

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example of FIG. 2, the geologic environment 210 can include fluids such as oil (o), water (w) and gas (g), which may be stratified in the reservoirs 211-1 and 211-2.

In the example of FIG. 2, the equipment 214 and 216 can include one or more of drilling equipment, wireline equipment, production equipment, etc. For example, consider the equipment 214 as including a drilling rig that can drill into a formation to reach a reservoir target where a well can be completed for production of hydrocarbons. As an example, the equipment 216 can include production equipment such as wellheads, valves, pump equipment, gas handling equipment, etc. As an example, one or more features of the system 100 of FIG. 1 may be utilized for operations in the geologic environment 210. For example, consider utilizing a drilling or well plan framework, a drilling execution framework, a production framework, etc., to plan, execute, etc., one or more drilling operations, production operations, etc.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of fluid (e.g., oil, water and/or gas) from well locations along flowlines interconnected at junctions with final delivery at a central processing facility (CPF). Where fluid includes solids (e.g., sand, etc.), one or more pieces of equipment may provide for solids removal, collection, etc.

In the example of FIG. 2, various portions of the network 240 may include conduits. For example, consider a perspective view of a geologic environment that includes two conduits which may be a conduit to Man1 and a conduit to Man3 in the network 240, where Man1, Man2 and Man3 are manifolds.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or other modeling. As an example, one or more methods, techniques, etc. may be performed using one or more sets of instructions, which may be, for example, the instructions 270 of FIG. 2.

As an example, various graphics in FIG. 2 may be part of a graphical user interface (GUI) that can be generated using executable instructions that may be executable locally and/or remotely using local and/or remote display devices (e.g., a mobile device, a workstation, etc.).

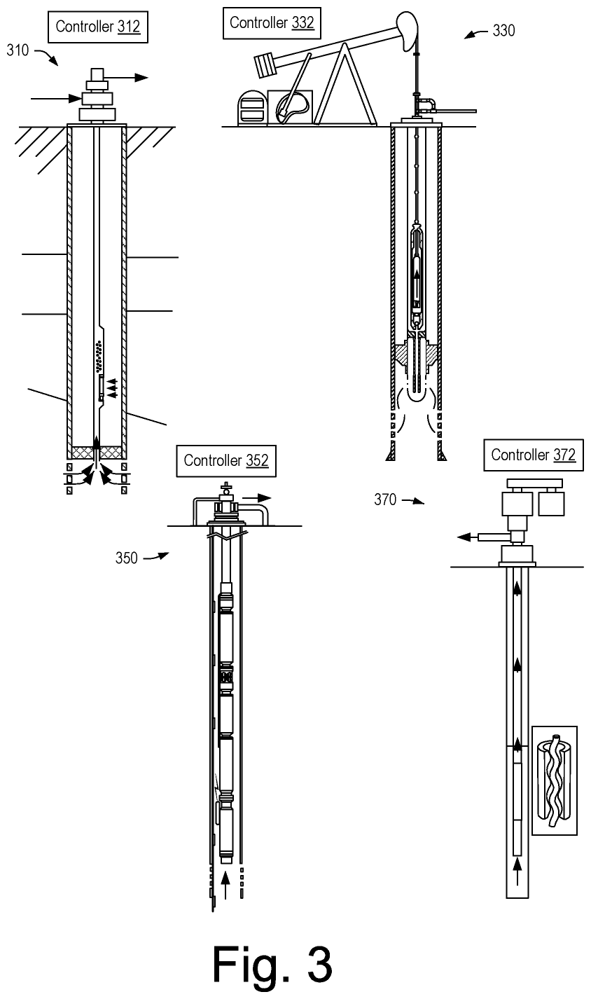

FIG. 3 shows examples of equipment 310, 330, 350 and 370 that can be utilized in the field to move fluid. As shown, the equipment 310 can include gas-lift equipment, the equipment 330 can include sucker rod pump equipment, the equipment 350 can include electric submersible pump (ESP) equipment, and the equipment 370 can include progressive cavity pump (PCP) equipment.

In FIG. 3, the equipment 310, 330, 350 and 370 can be artificial lift equipment, where one or more controllers 312, 332, 352 and 372 can be included with the equipment 310, 330, 350 and 370 and/or operatively coupled to the equipment 310, 330, 350 and 370. In such an example, one or more features of the system 250 may be included in the one or more controllers 312, 332, 352 and 372 and/or operatively coupled to the one or more controllers 312, 332, 352 and 372.

Artificial lift equipment can add energy to a fluid column in a wellbore with the objective of initiating and/or improving production from a well. Artificial lift systems can utilize a range of operating principles (e.g., rod pumping, gas lift, electric submersible pumps, etc.). As such, artificial lift equipment can operate through utilization of one or more resources (e.g., fuel, electricity, gas, etc.).

Gas lift is an artificial-lift method in which gas is injected into production tubing to reduce hydrostatic pressure of a fluid column. The resulting reduction in bottomhole pressure allows reservoir liquids to enter a wellbore at a higher flow rate. In gas lift, injection gas can be conveyed down a tubing-casing annulus and enter a production train through a series of gas-lift valves. In such an approach, a gas-lift valve position, operating pressure and gas injection rate may be operational parameters (e.g., determined by specific well conditions, etc.).

A sucker rod pump is an artificial-lift pumping system that uses a surface power source to drive a downhole pump assembly. For example, a beam and crank assembly can create reciprocating motion in a sucker rod string that connects to a downhole pump assembly. In such an example, the pump can include a plunger and valve assembly to convert the reciprocating motion to vertical fluid movement. As an example, a sucker rod pump may be driven using electricity and/or fuel. For example, a prime mover of a sucker rod pump can be an electric motor or an internal combustion engine.

An ESP is an artificial-lift system that utilizes a downhole pumping system that is electrically driven. In such an example, the pump can include staged centrifugal pump sections that can be specifically configured to suit production and wellbore characteristics of a given application. ESP systems may provide flexibility over a range of sizes and output flow capacities.

A PCP is a type of a sucker rod-pumping unit that uses a rotor and a stator. In such an approach, rotation of a rod by means of an electric motor at surface causes fluid contained in a cavity to flow upward. A PCP may be referred to as a rotary positive-displacement unit.

In the examples of FIG. 3, one or more sensors may be included. For example, consider a gauge coupled to a downhole end of an ESP where signals from sensors of the gauge can be transmitted to surface equipment using a power cable and/or a dedicated gauge cable. For example, consider the PHOENIX gauge (Schlumberger Limited, Houston, Texas), which include sensors that can measure intake pressure, temperature, motor oil temperature, winding temperature, vibration, current leakage and/or pump discharge pressure. A gauge may be operatively coupled to a controller, which may, for example, provide controls for backspin of an ESP, sanding of an ESP, flux of an ESP and gas lock of an ESP. For example, during operation where sand is present (e.g., suspended solid matter, etc.), sand may accumulate in one or more stages of an ESP where a control scheme may act to rid the ESP of at least a portion of the sand.

As an example, a PCP may be suitable for use in production for wells characterized by highly viscous fluid and high sand cut where the PCP has some sand-lifting capability. However, sand may accumulate where a control scheme may be utilized to rid the PCP of at least a portion of the sand.

As an example, a sucker rod pump may be operable as a stroke-through pump to release sand and other material. In such an example, to minimize damage to a plunger and barrel, a grooved-body plunger may be used to catch and carry the sand away from those components.

As an example, gas lift equipment may be utilized in applications where abrasive materials, such as sand, may be present and can be used in low-productivity, high-gas/oil ratio-wells or deviated wellbores. As an example, gas lift equipment such as pocketed mandrels can utilize slickline-retrievable gas lift valves, which may be pulled and replaced without disturbing tubing.

As an example, equipment may include water flooding equipment. For example, consider an enhanced oil recovery (EOR) process in which a small amount of surfactant is added to an aqueous fluid injected to sweep a reservoir. In such an example, presence of surfactant reduces the interfacial tension between oil and water phases and may also alter wettability of reservoir rock (e.g., to improve oil recovery). In such an example, movement of fluid (e.g., oil and/or water) and/or presence of surfactant may carry particles of the reservoir rock to a production well or production wells where such particles (e.g., sand) can result in a sand event, whether one or more of the production well or wells include artificial lift equipment or not. As water flooding becomes more prevalent globally, an increase in sand related issues may be expected (e.g., sand influx into production wells).

As an example, equipment can include a choke or chokes, which can include a surface choke and/or a downhole choke. A choke is a device that includes an orifice that can be used to control flow of fluid through the orifice, for example, to control fluid flow rate, downstream system pressure, etc. Chokes are available in various configurations, which include fixed and adjustable chokes. An adjustable choke enables fluid flow and pressure parameters to be changed as desired (e.g., for process, production, etc.).

An adjustable choke includes a valve that can be adjusted to control well operations, for example, to reduce pressure of a fluid from high pressure in a closed wellbore to atmospheric pressure. An adjustable choke valve may be adjusted (e.g., fully opened, partially opened or closed) to control pressure drop. As an example, an adjustable choke may be manually adjustable or adjustable via a controller that may be integral to or operatively coupled to the adjustable choke. A controller for an adjustable choke may respond to locally generated and/or remotely generated signals.

A downhole choke or bottom hole choke can be a downhole device used to control fluid flow under downhole conditions. As an example, a downhole choke may be removable via slickline intervention where the downhole choke may be located in a landing nipple in a tubing string. In some scenarios, a downhole chock may be used as a flow regulator and to take part of the pressure drop downhole, which may help to reduce potential of hydrate issues.

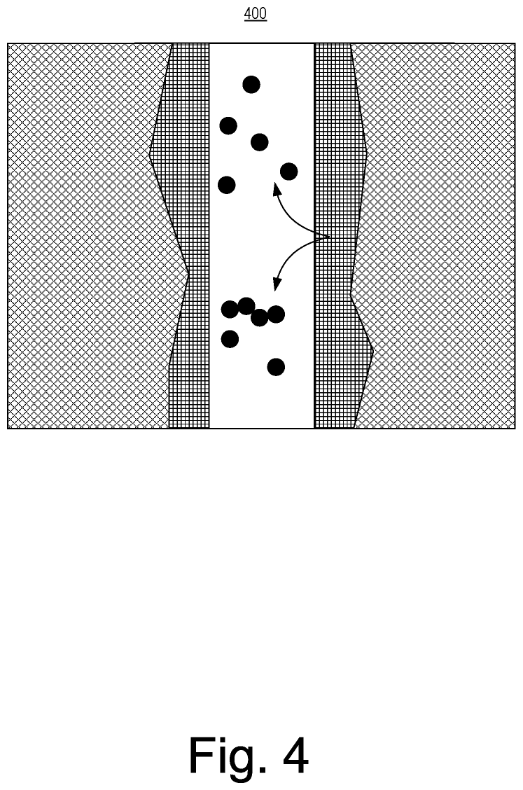

FIG. 4 shows a diagram 400 of a portion of a wellbore surrounded by near wellbore damaged material of a sand formation. In such an example, fluid from the sand formation, represented by arrows, can transport sand (e.g., solids) into the wellbore, which may rise, remain stationary and/or fall depending on orientation, fluid flow rate, fluid flow profile, etc. For example, where fluid velocity is relatively high, sand may be carried in a direction of the flow (e.g., to surface, etc.); whereas, where fluid velocity is relatively low, sand may be carried in a direction of gravity. Such examples depend on fluid properties (e.g., viscosity, etc.) and sand characteristics (e.g., density, size, shape, charge, etc.).

As to production from a well, solids (e.g., sand, etc.) can refer to small formation particles known as fines that may be produced with the reservoir fluid. Solids production tends to be undesirable and, if severe, may demand one or more types of remedial action to control and/or prevent solids production (e.g., consider gravel packing or sand consolidation). In geology, sand can refer to a detrital grain between 0.0625 mm and 2 mm in diameter where sand is larger than silt but smaller than a granule according to the Udden-Wentworth scale. Sand may also be a term used for quartz grains or for sandstone.

Failure at a wellbore can be characterized by damage to surrounding formation rock. The consequence of sandstone reservoir rock failure may lead to sand production. This phenomenon can have negative impact on lifting cost and economics of field development. Further, metal erosion due to solids production can result in loss of integrity and hydrocarbon leakage. An inadequate decision as to completion type can raise a risk of field viability.

To facilitate solids management over the life of a field and to maintain economical productivity, a method can provide for accurate prediction of solids production, for example, through usage of physical components that account for various physical phenomena. In such an example, a geomechanics component can be utilized when addressing solids production where such a geomechanics component may include or be integrated with one or more monitoring technologies, machine learning technologies, etc. In such an example, a method may provide, in an advanced fashion, a critical drawdown pressure (CDDP) (e.g., or a schedule or log of CDDPs, etc.).

Pressure drawdown or drawdown pressure is a differential pressure that drives fluids from a reservoir into a wellbore. The drawdown, and therefore the production rate, of a producing interval may be controlled by one or more pieces of equipment (e.g., surface choke, downhole choke, artificial lift equipment, etc.). Reservoir conditions, such as the tendency to produce sand, may limit the drawdown that may be safely applied during production before damage or unwanted sand production occurs. For example, if drawdown pressure is too high, damage and/or unwanted sand production may occur; whereas, if drawdown pressure is too low, production rate may be sub-optimal. A critical drawdown pressure (CDDP) can be defined as the maximum difference between reservoir pressure and downhole flowing pressure (e.g., bottom hole flowing pressure) that a formation can withstand without sand being produced along with formation fluid as illustrated in FIG. 4. Another pressure differential can be determined with respect to wellhead pressure and downhole pressure, which may be bottom hole pressure.

As to drawdown pressure, equipment (e.g., a choke, artificial lift equipment, etc.) may be controlled to reduce flow in a manner that causes an increase in downhole flowing pressure (e.g., bottom hole flowing pressure) such that the difference between the reservoir pressure and the downhole flowing pressure is decreased. Conversely, such equipment may be suitably controlled to increase flow in a manner that causes a decrease in downhole flowing pressure (e.g., bottom hole pressure) such that the difference between the reservoir pressure and the downhole flowing pressure is increased.

As explained, a system such as the system 250 of FIG. 2 can be implemented locally and/or remotely. For example, the system 250 may be a distributed system with one or more local components and one or more remote components.

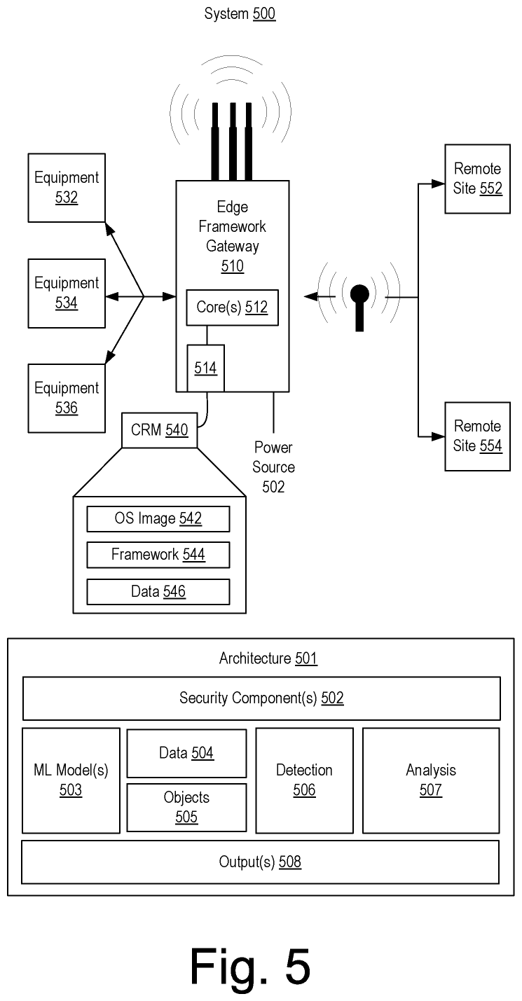

FIG. 5 shows an example of a system 500 and an example of an architecture 501 where the system 500 can include various local components that can be in communication with one or more remote components. As shown in the example of FIG. 5, the architecture 501 can provide for one or more security components 502, one or more machine learning models 503, data 504, objects 505, detection techniques 506 (e.g., recognition, detection, prediction, etc.), analysis techniques 507 and output(s) 508.

As shown, the system 500 can include a power source 502 (e.g., solar, generator, grid, etc.) that can provide power to an edge framework gateway 510 that can include one or more computing cores 512 and one or more media interfaces 514 that can, for example, receive a computer-readable medium 540 that may include one or more data structures such as an operating system (OS) image 542, a framework 544 and data 546. In such an example, the OS image 542 may cause one or more of the one or more cores 512 to establish an operating system environment that is suitable for execution of one or more applications. For example, the framework 544 may be an application suitable for execution in an established operating system in the edge framework gateway 510.

In the example of FIG. 5, the edge framework gateway 510 (“EF”) can include one or more types of interfaces suitable for receipt and/or transmission of information. For example, consider one or more wireless interfaces that may provide for local communications at a site such as to one or more pieces of local equipment, which can include equipment 532, equipment 534 and equipment 536 and/or remote communications to one or more remote sites 552 and 554. In such an example, lesser or more equipment may be included.

As an example, the equipment 532, 534 and 536 may include one or more types of equipment such as the equipment 310, the equipment 330, the equipment 350 and the equipment 370 of FIG. 3. As an example, equipment may include non-artificial lift equipment and/or artificial lift equipment.

As an example, the EF 510 may be installed at a site where the site is some distance from a city, a town, etc. In such an example, the EF 510 may be accessible via a satellite communication network and/or one or more other networks where data, control instructions, etc., may be transmitted, received, etc.

As an example, one or more pieces of equipment at a site may be controllable locally and/or remotely. For example, a local controller may be an edge framework-based controller that can issue control instructions to local equipment via a local network and a remote controller may be a cloud-based controller or other type of remote controller that can issue control instructions to local equipment via one or more networks that reach beyond the site. As an example, a site may include features for implementation of local and/or remote control. As an example, a controller may include an architecture such as a supervisory control and data acquisition (SCADA) architecture.

A communications satellite is an artificial satellite that can relay and amplify radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite. As an example, information may be acquired using one or more types of satellites, including, for example, imagery satellites (e.g., Sentinel, etc.).

High frequency radio waves used for telecommunications links travel by line-of-sight, which may be obstructed by the curve of the Earth. Communications satellites can relay signal around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency.

As shown in the example of FIG. 5, the EF 510 may be deployed where it can operate locally with the one or more pieces of equipment 532, 534 and 536, etc. As an example, the EF 510 may include switching and/or communication capabilities, for example, for information transmission between equipment, etc.

As desired, from time to time, communication may occur between the EF 510 and one or more remote sites 552, 554, etc., which may be via satellite communication where latency and costs are tolerable. As an example, the CRM 540 may be a removable drive that can be brought to a site via one or more modes of transport. For example, consider an air drop, a human via helicopter, plane, boat, etc.

As to an air drop, consider dropping an electronic device that can be activated locally once on the ground or while being suspended by a parachute en route to ground. Such an electronic device may communicate via a local communication system such as, for example, a local WIFI, BLUETOOTH, cellular, etc., communication system. In such an example, one or more data structures may be transferred from the electronic device (e.g., as including a CRM) to the EF 510. Such an approach can provide for local control where one or more humans may or may not be present at the site. As an example, an autonomous and/or human controllable vehicle at a site may help to locate an electronic device and help to download its payload to an EF such as the EF 510. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As to drones, consider a drone that includes one or more features of one or more of the DJI MATRICE 210 RTK drone, which can have a takeoff weight of 6.2 kg (include battery and max 1.2 kg payload), a maximum airspeed of 13-30 m/s, a range of 500 m to 1 km with standard radio/video though it may be integrated with other systems for further range from base, a flight time of 15-30 minutes (e.g., depending on battery and payload choices, etc.). As an example, a gateway may be a mobile gateway that includes one or more features of a drone and/or that can be a payload of a drone.

As shown in FIG. 5, an EF may execute within a gateway such as, for example, an AGORA gateway (e.g., consider one or more processors, memory, etc., which may be deployed as a “box” that can be locally powered and that can communicate locally with other equipment via one or more interfaces). As an example, one or more pieces of equipment may include computational resources that can be akin to those of an AGORA gateway or more or less than those of an AGORA gateway. As an example, an AGORA gateway may be a network device with various networking capabilities.

As an example, a gateway can include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm).

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke, a pump, etc.).

As an example, a gateway may include hardware (e.g. circuitry) that can provide for operation of a drone. As an example, a gateway may be a drone controller and a controller for other equipment where the drone controller can position the gateway (e.g., via drone flight features, etc.) such that the gateway can control the other equipment.

As an example, a mobile gateway may be operable in one or more safety modes. For example, if conditions change, a mobile gateway may be able to issue one or more safety instructions and then fly away to protect the mobile gateway. In such an example, the mobile gateway and data therein (e.g., a black box) may be kept safe. Such an approach may be utilized, for example, where an operational issue arises, where a site is invaded by one or more intruders, etc. For example, consider an intruder that aims to interfere with equipment, which may be to damage equipment, alter the equipment, steal fluid, etc. In such an example, a mobile gateway may detect and/or receive a detection signal and place equipment in a suitable state and then fly or otherwise move away to protect itself. Where an intruder departs, the mobile gateway may return and run an assessment to determine whether a return to operation is possible or not. As mentioned, where a gateway include satellite communication circuitry, a gateway may issue one or more signals such as one or more distress or SOS types of signals that may alert as to a threat, which may be imminent and/or in progress.

As an example, a gateway itself may include one or more cameras such that the gateway can record conditions. For example, consider a motion detection camera that can detect the presence of an object. In such an example, an image of the object and/or an analysis (e.g., image recognition) signal thereof may be transmitted (e.g., via a satellite communication link) such that a risk may be assessed at a site that is distant from the gateway.

As an example, a gateway may include one or more accelerometers, gyroscopes, etc. As an example, a gateway may include circuitry that can perform seismic sensing that indicates ground movements. Such circuitry may be suitable for detecting and recording equipment movements and/or movement of the gateway itself.

As explained, a gateway can include features that enhance its operation at a remote site that may be distant from a city, a town, etc., such that travel to the site and/or communication with equipment at the site is problematic and/or costly. As explained, a gateway can include an operating system and memory that can store one or more types of applications that may be executable in an operating system environment. Such applications can include one or more security applications, one or more control applications, one or more simulation applications, etc.

As an example, various types of data may be available, for example, consider real-time data from equipment and ad hoc data. In various examples, data from sources connected to a gateway may be real-time, ad hoc data, sporadic data, etc. As an example, lab test data may be available that can be used to fine tune one or more models (e.g., locally, etc.). As an example, data from a framework such as the AVOCET framework may be utilized where results and/or data thereof can be sent to the edge. As an example, one or more types of ad hoc data may be stored in a database and sent to the edge.

As to real-time data, it can include data that are acquired via one or more sensors at a site and then transmitted after acquisition, for example, to a framework, which may be local, remote or part local and part remote. Such transmissions may be as streams (e.g., streaming data) and/or as batches. As to batches, a buffer may be utilized where an amount of data may be stored and then transmitted as a batch. In various instances, real-time data may be characterized using a sampling rate or sampling frequency. For example, consider 1 Hz as a sampling frequency that is adequate to track various types of physical phenomena that can occur during well operations. As an example, a sensor and/or a framework may provide for adjustment of sampling (e.g., at the sensor and/or at the framework). In various instances, data from multiple sensors may be at the same sampling rate or at one or more sampling rates. As an example, data sampling can be at a rate sufficient to provide for detection, prediction, etc., as to a probability of occurrence of a solids event at a future time. In such an example, the sooner data are analyzed, the sooner such detection, prediction, etc., can occur. For example, consider a system where advance notice of a risk of a solids event can be greater than 10 minutes, greater than 30 minutes, greater than 1 hour, etc., such that one or more control actions can be taken to mitigate the risk of the solids event.

As explained, various systems may operate in a local manner, optionally without access to a network such as the Internet. For example, a site may be relatively remote where satellite communication exists as a main mode of communication, which may be costly and/or low bandwidth. In such scenarios, security may resort to local features rather than a remote feature such as a remote authentication server.

An authentication server can provide a network service that applications use to authenticate credentials, which may be or include account names and passwords of users (e.g., human and/or machine). When a client submits a valid credential or credentials to an authentication server, the authentication server can generate a cryptographic ticket that the client can subsequently use to access one or more services.

In the example of FIG. 5, the edge framework 544 can be an edge-enabled data processing framework. As an example, such a framework can include features to perform one or more of the followings tasks: real-time data cleansing to synchronize information from existing well metrology (e.g., wellhead, tubing, flow, ESP, etc.); executing one or more machine learning (including self-learning) models in real-time (e.g., one or more ML geomechanics models that can predict solids influx, etc.); and conveying a control set point to a flowline regulator (e.g., an actuatable valve, etc.) and/or one or more other pieces of equipment.

The system 500 can be part of an infrastructure that serves as a secure gateway to transmit surveillance into an operator's surveillance station or its own surveillance platform. The presence of such a gateway can also support an operator for introduction of one or more additional IIOT (industrial internet of things) implementations.

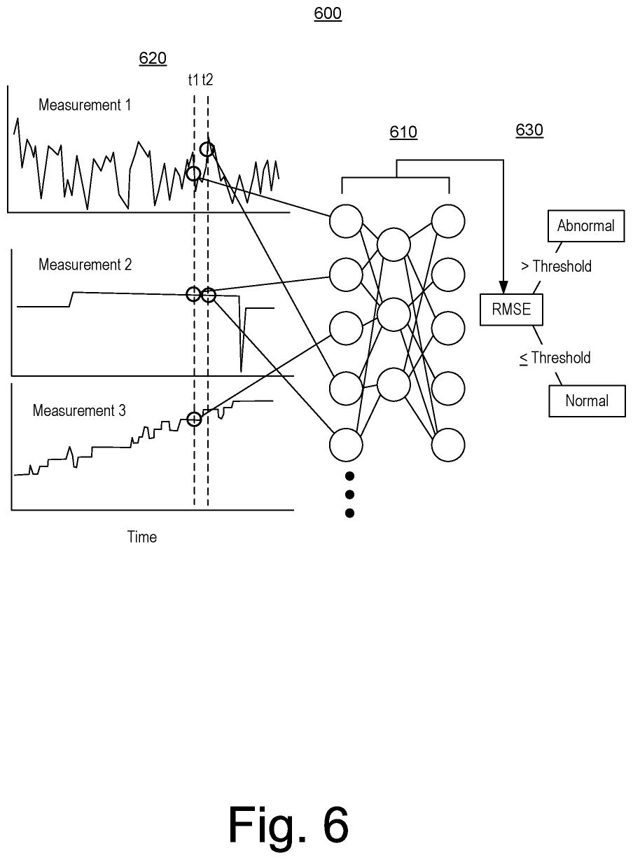

FIG. 6 shows an example of a system 600 that includes a machine learning model 610 that can receive data 620 from one or more sensors and make determinations 630 based at least in part on at least a portion of the data. In the example of FIG. 6, the ML model 610 can be a ML model for solids influx prediction (e.g., sand influx prediction). As explained, solids influx can depend on various factors, which can include geomechanical factors, flow factors, pressure factors, etc.

As shown in the example of FIG. 6, the data 620 can include time series data, which may be multi-variate time series data from a sensor network topology in the field as operatively coupled to an edge framework. In such an example, the data can provide for unsupervised training of an anomaly detection model within a workflow for real-time solids influx detection in a wellbore. For example, the ML model 610 can be an anomaly detection model.

As an example, a workflow can include collation of multivariate and real-time data streams of healthy well-functioning sensors for the purpose of modeling and learning well dynamics. In such an example, to ensure model robustness, a model can be trained on multiple data sets. Further, data from multiple wells may be utilized to improve model robustness. In such a workflow, training of a model can be performed using healthy data (e.g., indicative of normal operation) that can benefit from low data availability of sand influx events. In an effort to increase accuracy, data leading to influx events (e.g., unhealthy data, indicative of abnormal operation) can be removed (e.g., filtered out, etc.). In such an approach, data availability of exact time of solid influx events (e.g., an accurate estimate of event start and stop times) can be provided.

As an example, a rigorous approach can be implemented in a manner that does not demand many solid influx events. For example, consider a training technique that can utilize data with minimal to no recorded solid influx events. In such an example, a production problem can be formulated as an unsupervised anomaly detection problem. In such an example, the ML model can learn from data indicative of healthy functioning of a well (or wells) such that, when an anomalous signal is observed, the trained ML model recognizes this anomalous signal and creates an alert, which may update a control feature.

As mentioned, a ML model can ingest healthy times series data after removal of data related to solid influx events. Such a ML model can act to compress the data and reconstruct it and, in the process, learning the features for healthy functioning. In such an example, when erroneous data are passed to the trained ML model, the ML model fails to reconstruct that data; hence, a reconstruction error can be used to detect anomalies.

In the example of FIG. 6, the system 600 shows the data 620 as including three example time series measurements; noting that there can be lesser or greater number of measurements, which may be limited at a site and/or based on outcomes for making a robust trained ML model. As shown, output of the ML model 610 of FIG. 6, per the determinations 630, can be either “normal” or “abnormal” where “abnormal” is a solids event identification. Such an approach may utilize a root mean square error (RMSE) as a metric that can be compared to a threshold where if the RMSE is less than or equal to the threshold, the output of the ML model 610 can be considered to be indicative of normal, healthy behavior; whereas, if the RMSE is greater than the threshold, the output of the ML model 610 can be considered to be indicative of abnormal, unhealthy behavior (e.g., a sand event).

As an example, a ML model can be an autoencoder. An autoencoder is a type of artificial neural network that can learn efficient codings of unlabeled data (unsupervised learning). Encoding can be validated and refined by attempting to regenerate the input from the encoding. An autoencoder learns a representation (encoding) for a set of data, which may in some instances be for purposes of dimensionality reduction. Such learning can be via training a network to ignore certain types of data (e.g., “noise”).

One or more of various types of autoencoders may be utilized. For example, consider a regularized autoencoder (e.g., sparse, denoising, contractive, etc.), which may be effective in learning representations for subsequent classification tasks. Another type is a variational autoencoder, which can be suitable as generative models. An autoencoder may be suitable for recognition, feature detection, anomaly detection, etc. As a generative model, an autoencoder can randomly generate new data that are similar to input data (e.g., training data).

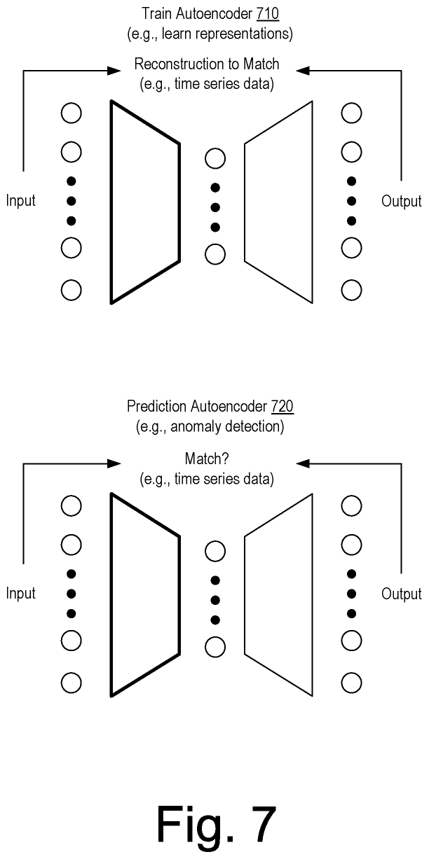

FIG. 7 shows an example of training an autoencoder 710 and an example of predicting using a trained autoencoder 720. As shown, training of the autoencoder 710 involves compression and decompression, or reconstruction. Training aims to make output look like input. Once trained, the compressor portion (encoder) and the decompressor portion (decoder) can be utilized as the trained autoencoder. As explained, a trained autoencoder can be a learned autoencoder that has learned representations and that can receive input data in an input dimensionality space and generate data in a reduced dimensionality space where that data can then be decompressed back to an original dimensionality space for comparison to the input data. In various examples, an encoder (compressor portion) may be utilized for reduction of input to a lesser dimension in a latent or feature space where the representation of the input in the latent or feature space may be utilized for one or more purposes (e.g., comparisons, rankings, etc.).

As shown in FIG. 7, the trained autoencoder 720, which may be referred to as a prediction autoencoder, can generate output based on input where the output and input can be compared to determine if a match exists. As explained, a match may be characterized using one or more metrics such as, for example, RMSE. Where RMSE is low, a match may be considered adequate and indicative of “normal” or “healthy” operation; whereas, if RMSE is higher, that means the match is not so good, which can indicate that the input represents a state (or states) that were not utilized during training such that the trained autoencoder reproduces the input poorly. As explained, such input can be an anomaly that did not exist or existed infrequently in training data.

As an example, an edge framework can use an autoencoder composed of a Fourier-encoder and a raw-decoder for detecting solids influx events. In such an example, the Fourier-encoder can receive raw time series field signals, perform a Fourier transform on the raw time series field signals and transforms them into a lower dimensional vector (e.g., in a feature of latent space). In such an approach, the raw-decoder can receive the lower dimensional vector as input to reconstruct the original raw time series field signals.

As explained, during training, a ML model can be trained using signals that correspond to normal operation (e.g., healthy signals) and hence, the trained ML model is built to generate only the signals that it was trained on. For classification/solids event detection, a method can include sampling output of a raw-decoder of a ML model to generate a test signal(s) and computing the RMSE between the generated signal(s) and the observed signal(s). As explained, when the computed RMSE is less than a defined threshold, the observed signal(s) can be safely categorized as “normal” (e.g., health signal input); otherwise it can be categorized as an “attack” event (e.g., abnormal or unhealthy signal input).

As an example, an autoencoder can include an encoder and a decoder that are each composed of a 1D residual convolution neural network (1D-Residual-CNN), which may help to avoid overfitting and vanishing-gradient issues. As an example, a method can include stochastic weight averaging during training to achieve better generalization on multiple wells. For example, a trained ML model may be specific to a particular well or may be more general and suitable for use on multiple wells. As an example, where data are utilized for training from multiple wells, the multiple wells may be selected according to one or more criteria such as, for example, proximity, depth, formation/reservoir type, etc.

As an example, where data are not visually indicative of “normal” and “abnormal” events, a method can include training that utilizes data for normal and abnormal events (e.g., data for healthy and unhealthy conditions). In such an example, controversial optimization may be utilized. For example, a ML model can be forced to generate signals that are closer to “normal” events and farther from “abnormal” events in an n-dimensional space, where n is the number of signals used in training.

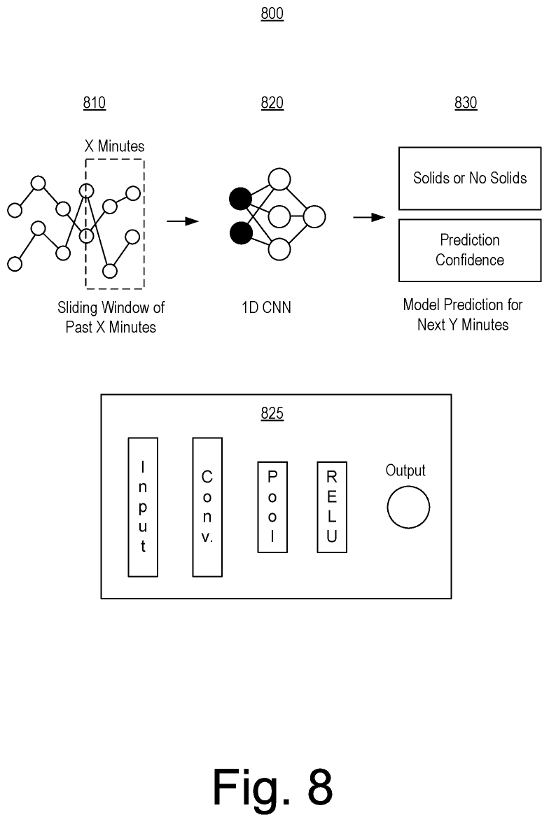

FIG. 8 shows an example of a method 800 that includes a sliding window block 810, a 1D convolution neural network block 820 and a model prediction block 830. As shown, a sliding window can be implemented per the sliding window block 810 for time series data where a window span may be selected. In the example of FIG. 8, the window span is selected to be five hours, noting that a lesser or greater time span may be selected. As an example, a window span may be selected on the basis of physical phenomena that occur prior to or during an event. For example, as to a solids event, it may exhibit behavior in one or more time series signals over a span of hours such that a window span can be selected to capture such behavior in the one or more of the time series signals.

As to the 1D convolution neural network (CNN) block 820, it can include an architecture, such as an example architecture 825, with various layers. For example, consider a 1D CNN that includes an input layer that takes a fixed length of a time series and passes the input to a convolutional layer. In such an example, the convolutional layer and a pooling layer can smooth the input. As shown, an RELU layer can apply an RELU non-linear transformation to the smoothed input. In the example architecture 825, the output layer can take a vector-valued result of the RELU layer. In such an example, the output layer may utilize one or more activation functions to provide one or more types of output (e.g., class probabilities, a continuous-valued response, counts, or some other type of response based on the choice of activation function).

As to convolution, it can help to diminish noise (e.g., via smoothing), for example, such that a resulting plot of time series data is less jagged. As explained, output of a convolution layer can be pooled, using a pooling layer. For example, consider applying average pooling with pools of a selected size (or sizes). The output of a pooling layer can be a smoother representation of the output of a convolution layer such that, for example, if signal, as in signal versus noise, exists in the input time series data, the signal may be easier to identify in an average pooling plot.

As explained, a 1D CNN can include convolutional and max pooling layers that apply smoothing to an input vector, which can be a fixed length sub-sequence of a time series (e.g., according to a window span, etc.). As an example, such a 1D CNN can be trained to learn smoothing parameters jointly with classification or regression parameters.

In the example of FIG. 8, the method 800 can include the model prediction block 830 where a prediction can be output, for example, as to an event or no event within a period of time that extends into the future, which may be output with a prediction confidence. For example, consider prediction of a solids event or a prediction of no solids event within the next hour where the prediction can have an associated confidence (e.g., within a range that may be greater than a threshold value, etc.).

As an example, a framework can include utilization of one or more ML models. For example, consider one or more types of 1D CNN ML models. As an example, ML models may be chained. For example, consider utilization of one or more ML models for each channel of time series data, which may, for example, smooth such time series data prior and make such smoothed time series data available to another ML model for purposes of training, prediction, etc.

A trial performed for time series data for two wells demonstrated suitable event detection. In the trial, the time series data spanned a period of time of 17 months for two wells: A1 and A5. Using time series data from the well A1, sixteen sand events were manually labelled. The labeled data were utilized as a training dataset for a 1D CNN ML model to generate a trained 1D CNN ML model. In the trial, testing was performed using the trained 1D CNN ML model and data for the well A5.

As to trial data, wells included ESP equipment that included sensors that provided various channels of time series data. As explained, data may be for one or more wells that include artificial lift equipment or not. And, where a well includes artificial lift equipment, it may include one or more types of artificial lift equipment, one or more types of sensors, etc. In various examples, a framework may be utilized for one or more wells that are subject to water flooding.

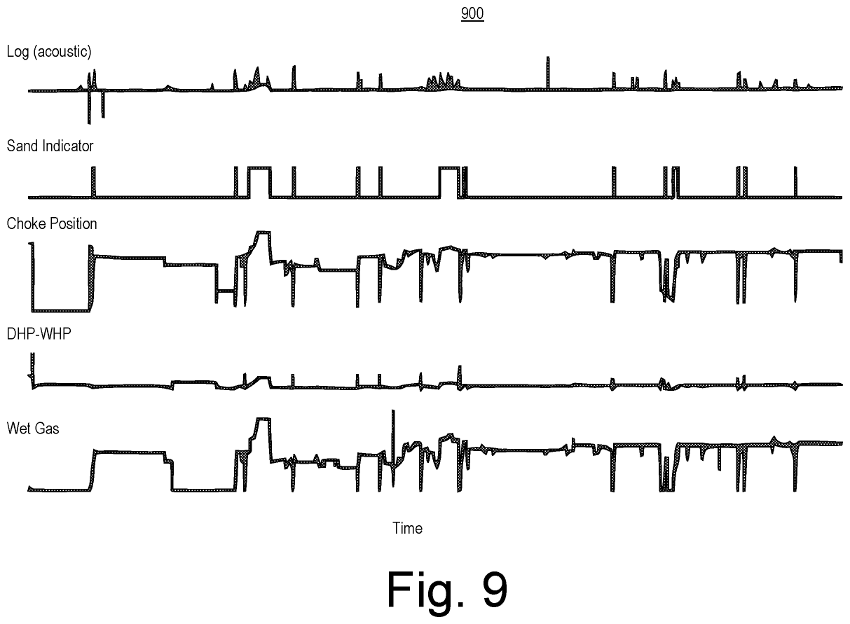

FIG. 9 shows time series plots 900 over a period of time of approximately 12 months. The time series plots 900 include an acoustic log channel (e.g., a topside acoustic sensor channel), a sand indicator channel, a choke position channel, a pressure differential channel (downhole pressure minus wellhead pressure), and a wet gas channel.

The time series plots 900 include the sand indicator channel as a labeled channel for sand events. For example, data from the topside acoustic sensor channel (acoustic log) can be utilized as an indicator of a sand event where such a channel will not predict a sand event but rather shows occurrence of a sand event when it actually occurs.

An acoustic sensor can be sensitive to impingement of solids (e.g., sand, etc.) against flow equipment. For example, consider an acoustic sensor at a wellhead or surface flowline where it detects sound made by particles impinging one or more surfaces of the wellhead.

As explained, a trained ML model can include an ability to predict occurrence of a sand event at a future time. For example, consider a trained ML model that can predict a sand event as likely to occur four hours into the future. In such an example, one or more control actions can be taken to mitigate conditions that may lead to the actual occurrence of the predicted sand event. As to a look-ahead period of time, a ML model may be trained in an appropriate manner based on one or more factors such as, for example, dynamics of physical phenomena, schedule of human presence at a wellsite (e.g., capable of implementing control on site), dynamics of one or more controllers, dynamics of one or more valves, dynamics of one or more pieces of artificial lift equipment, etc.

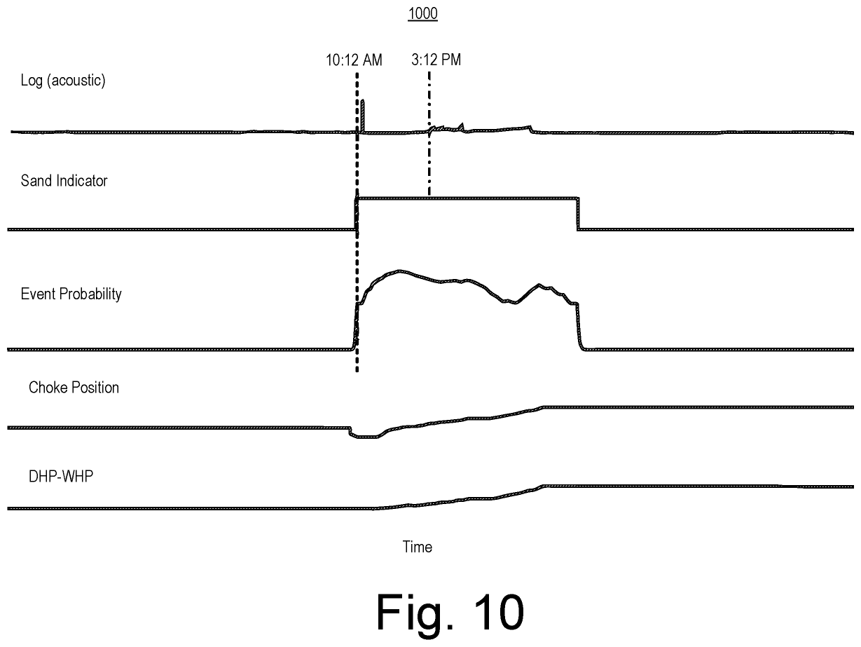

FIG. 10 shows time series plots 1000 over a period of time of approximately 2 days (e.g., approximately 48 hours). The time series plots 1000 include acoustic log channel (e.g., a topside acoustic sensor channel), a sand indicator channel, an event probability channel, a choke position channel, and a pressure differential channel (downhole pressure minus wellhead pressure). As shown, at approximately 10:12 AM the trained ML model detects an event that is approximately 5 hours ahead of detection by an acoustic sensor. At approximately 3:12 PM, various signals are visible within the acoustic log channel (e.g., about 5 hours after indication of a sand event by the sand indicator). As shown, at approximately 10:12 AM, the sand indicator increases and the event probability (e.g., confidence of the sand indicator) also increases. As to a spike in the acoustic channel, it can be an artifact as the shape of the spike is not akin to the shape of the signals that are indicative of sand in fluid.

In the example plots 1000 of FIG. 10, the choke position channel shows a change in choke position, which may, given other data, be associated with an increased risk of a sand event at a future time. As an example, a method can include controlling one or more pieces of equipment, which can be or include flow equipment such as, for example, a choke. In the example plots 1000 of FIG. 10, the pressure differential raises gradually over time, which can be responsive to one or more changes in the choke position. As explained, pressure differential can be a factor that effects generation of sand and/or flow of sand into production tubing. As to generation of sand, pressure differential may impact near borehole quality of a reservoir, which may cause breaking of reservoir rock and generation of sand. As an example, a time over which a choke position is changed may impact sand generation. For example, a rapid step change in choke position may have a larger impact than a series of small changes in choke position.

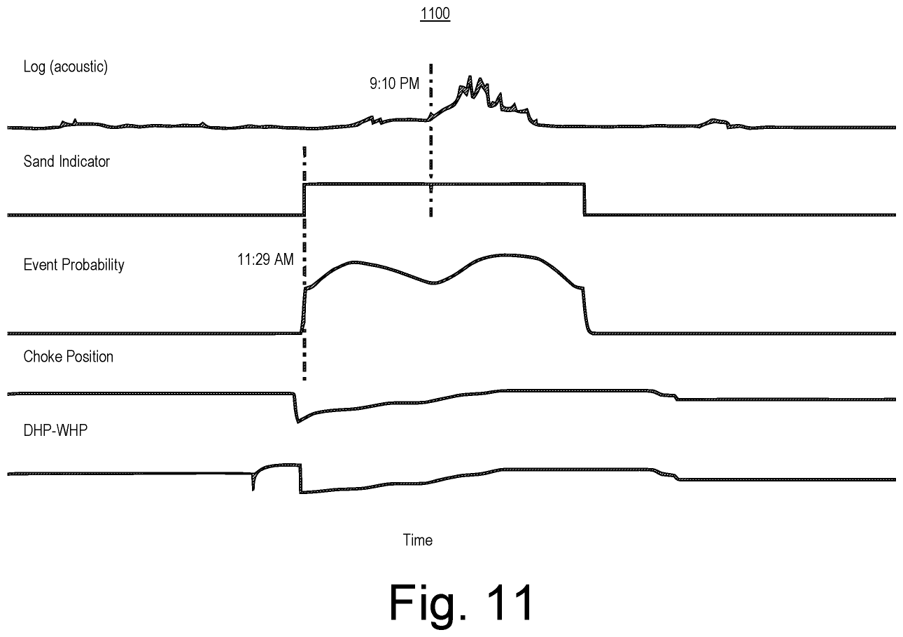

FIG. 11 shows time series plots 1100 over a period of time of several days. The time series plots 1100 include an acoustic log channel (e.g., a topside acoustic sensor channel), a sand indicator channel, an event probability channel, a choke position channel, and a pressure differential channel (downhole pressure minus wellhead pressure). As shown, at approximately 11:29 AM the trained ML model detects an event that is approximately 9.5 hours ahead. At approximately 9:10 PM, various signals are visible within the acoustic log channel. As shown, the sand indicator increases and the event probability (e.g., confidence of the sand indicator) also increases.

As shown in the example plots 1100, a change in choke position occurs, which may be in an effort to reduce the pressure differential. Such a change in choke position and rise and/or fall in differential pressure may lead to an increased risk of a sand event, as may be determined using a trained ML model.

As explained, sand events can be manually and/or otherwise marked in training data (e.g., labeled), for example, based on a channel of a well such as a normalized log-transformed topside acoustic sensor channel. In such an example, an event can start when the sensor exceeds a baseline value by a certain percent (e.g., consider 15 percent, etc.) and stops when the signal returns to the baseline value (e.g., or within a range of the baseline value such as 3 percent, etc.). As an example, events with a duration less than a number of minutes (e.g., 10 minutes, etc.) may be ignored as they can be assumed to be noise in the time series data. As an example, a sand event may be labeled in data as including a start time and an end time. As explained, commencement of a start time of a sand event can be a desirable event to detect, particularly in advance to allow time for control action(s).

As explained, a trained ML model can be tested on well time series data. As explained, the well A5 data were utilized for testing where the trained ML model (trained on the well A1 data) successfully detected disturbances in the topside acoustic sensor data track ahead of time or in real-time. The plots 1000 and 1100 of FIGS. 10 and 11 show these results where a prediction of about four to nine hours was obtained through execution of the trained ML model.

As an example, a trained ML model can be sensitive to phenomena such as an increase in downhole pressure. For example, a trained ML model may predict an increase in downhole pressure and/or associated phenomena such as, for example, an increase in density. In a vertical portion of a wellbore, an increase in density can cause an increase in downhole pressure due to the fluid column that is above the downhole pressure positon in the borehole. As to an increase in density, one reason can be a greater presence of particles such as, for example, sand. In such an example, as sand content of fluid increases, the density of the fluid increases, which can thereby result in an increase in pressure in a borehole (e.g., a wellbore). While sand is mentioned, other material can be limestone, chalk, etc., which may act to increase density due to material influx.

As explained, a drawdown pressure of a well may be adjustable via one or more mechanisms (e.g., equipment, etc.). Where solid particle influx results in an increase in downhole pressure, a control action may be taken to reduce the drawdown pressure. Such an approach can cause an ebb in production of fluid from a well where, for example, influx of solid particles may be reduced.

As an example, a sand event may be mitigating in one or more manners. For example, consider controlling an ESP as to RPM such that a flow rate changes. Or, for example, consider adjusting an amount of gas delivered to a gas lift valve or gas lift valves disposed in a well. In such an example, a gas lift injection rate (GLIR) may be controlled in a manner that can mitigate a risk of a sand event. As mentioned, a choke may be adjusted. In various examples, a well may include an automated choke valve that can be controlled via a control signal. Where an automated choke valve is presented, a framework may be operatively coupled to the automated choke valve to make one or more adjustments to mitigate risk of a sand event. As an example, a framework may be operatively coupled to ESP equipment, gas lift equipment, PCP equipment, sucker rod pump equipment, surface pump equipment, water flooding equipment, etc., where the framework can output a signal or signals that act to control such equipment to mitigate a risk of a sand event (e.g., or other type of solid material event).

As to solids in fluid, surface equipment may include one or more collection chambers for solids where each collection chamber can hold a particular amount (e.g., volume or mass) of solids that are separated out of fluid. In such an example, a framework may provide predictions as to solids in fluid that may act to fill a collection chamber such that planning can occur for emptying the collection chamber. In such an approach, a solids event may or may not be mitigated while an increase in volume of solids in a collection chamber can be predicted, which, as mentioned, may lead to scheduling a time for emptying the collection chamber.

As an example, a framework may provide predictions as to solids in fluid that may act to erode equipment. In such an example, a prediction may be mitigated or not while an increase in solids-based erosion may be determined based on such a prediction. For example, where a prediction as to increased solids occurs, an erosion model may be utilized to compute a rate of erosion, an amount of erosion, etc., which may be utilized in determining a remaining useful life of equipment, a risk of compromising equipment, a risk of leakage of fluid from equipment, etc.

In various examples, output of a framework can be utilized to manage and/or account for one or more solids-related bottlenecks, which can include one or more erosion bottlenecks, one or more collection chamber bottlenecks, etc. Control aspects can include control of completions design, control of perforation locations and characteristics, drawdown pressure and flow rate (e.g., of fluid into a wellbore). In such an example, completions design and perforation locations and characteristics may be fixed such that control focuses on one or more of drawdown pressure and flow rate, which may be related. As an example, equipment may be controlled based at least in part on output from a framework that utilizes one or more ML models where control of such equipment can be for drawdown pressure and/or flow rate.

As to water flooding, conformance can be a factor, along with interfacial tension as to water wet, oil wet or mixed wet of reservoir rock. As an example, a framework may be operatively coupled to water flooding equipment. For example, consider control of conformance and interfacial tension (IFT). In such an example, control may aim to make the reservoir rock more water wet via chemical injection (e.g., surfactants, etc.). As to conformance, water flooding direction can be controlled (e.g., direction of push, etc.) and viscosity. In such an example, one or more of water influx and/or water viscosity can be controlled (e.g., via polymers, etc.). For example, consider control of one or more pumps that pump water and/or one or more chemical injectors, mixers, etc.

As explained, a framework may utilize a geomechanics real-time model. As explained, failure at a wellbore can be characterized by damage to formation rock. The consequence of sandstone reservoir rock failure may lead to sand production. This phenomenon can have a negative impact on lifting cost and economics of field development. As explained, metal erosion due to sand production can result in loss of integrity and hydrocarbon leakage. Poor decisions on completion type can risk viability of a field.

As explained, a framework can utilize a geomechanical model, which may be in the form of a geomechanics component that can be utilized when addressing solids production where such a geomechanics component may include or be integrated with one or more monitoring technologies, machine learning technologies, etc. In such an example, a method may provide, in an advanced fashion, a critical drawdown pressure (CDDP).

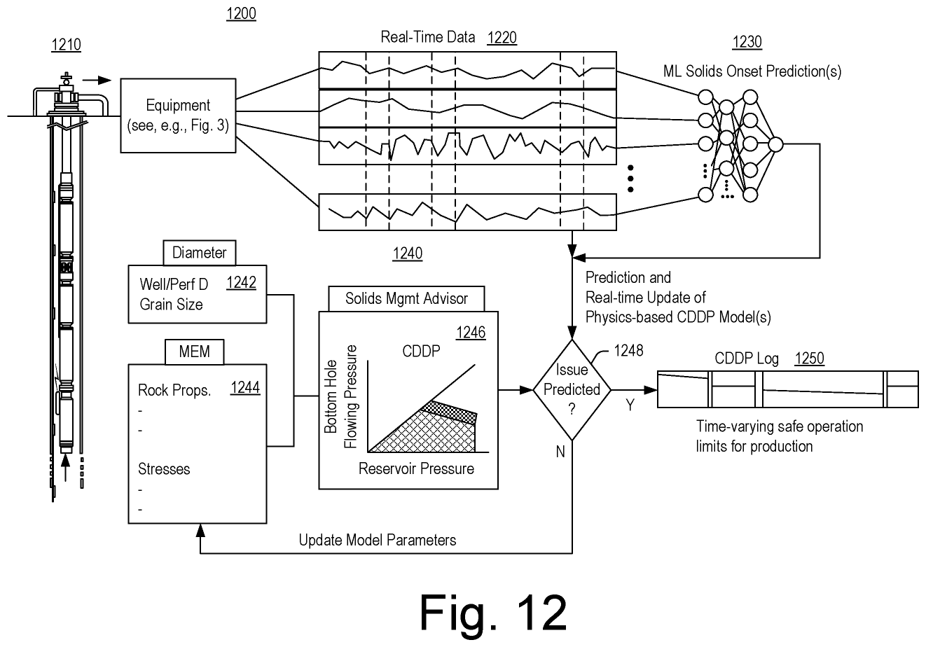

FIG. 12 shows an example of a system 1200 with respect to equipment 1210 of a well that includes various sensors that can output time series data 1220, which can be real-time sensor measurements. As explained, such time series data can be utilized by one or more ML models 1230 such as, for example, a ML model for solids event predictions (e.g., onset of a sand event or other solids event).

In the example of FIG. 12, the system 1200 includes various components 1240 that can be operatively coupled. For example, a diameter component 1242 can provide information such as well and/or perforation diameters and grain size of solids, a mechanical earth model (MEM) component 1244 can be a geomechanics component that can utilize rock properties (e.g., UCS, Young's modulus, Poisson's ratio, etc.) and stresses (e.g., overburden stress, pore pressure, minimum horizontal stress, maximum horizontal stress, horizontal stress azimuth, etc.). As shown, the various components 1240 can include a solids management advisor component 1246 that receives information from the components 1242 and 1244 for purposes of determining a critical drawdown pressure (CDDP), which may be represented as a plot of downhole flowing pressure (e.g., bottom hole flowing pressure, etc.) and reservoir pressure.

In the example of FIG. 12, the various components 1240 can include a decision component 1248 that can receive information from the solids management advisor component 1246 and can receive at least a portion of the time series data 1220 and/or output from the one or more ML models 1230. As shown in FIG. 12, the decision component 1248 can make decisions as to whether a solids event is predicted (e.g., a sand event, etc.). Where the decision component 1248 decides that such an event is not predicted, the system 1200 can update the MEM component 1244 based at least in part on the data 1220 and/or output of the one or more ML models 1230. In such an example, the MEM component 1244 can be up to date based at least in part on a portion of the time series data 1220. Where the decision component 1248 indicates that a solids event is predicted, the system 1200 can output information 1250, which may be in the form of a CDDP log, which can include time varying safe operation limits for production of fluid from the well via the equipment 1210.

As explained, CDDP can be a value of drawdown pressure that at or beyond which solids (e.g., sands, etc.) are carried into fluid being produced from a reservoir. As explained with respect to the diagram 400 of FIG. 4, damage to a formation adjacent a wellbore can be a source of solids and condition of a formation near a wellbore can depend on operational conditions such as, for example, drawdown pressure.

As an example, a method may aim to operate well equipment in a manner to optimize production while reducing risk of solids being carried into produced fluid. As an example, the output information 1250 can provide ranges, limits, instructions, etc., that pertain to control of drawdown pressure via one or more pieces of equipment (e.g., a choke, artificial lift equipment, etc.). For example, where a solids event is predicted to occur at a future time, the system 1200 can provide for generation of output to mitigate risk of actual occurrence of the solids event. In such an example, the output can be or include one or more instructions for control of one or more pieces of equipment at a site. As explained, a choke or other equipment may be controllable where, for example, a control instruction can cause a reduction in flow of fluid from a well to thereby reduce a drawdown pressure such that the drawdown pressure is less than a critical drawdown pressure (CDDP).

As an example, a system can include a mechanical earth model (MEM) for geomechanics that can be focused on one or more reservoir sections and fit for the purpose of analyzing the solids failure tendency during hydrocarbon production. For example, a workflow can include constructing an initial 1D MEM to derive rock mechanical properties, pore pressure and in-situ stress state for a well. Such a model can be validated with wellbore stability analysis, for example, by comparing predicted drilling induced wellbore failure(s) with actual drilling observations (e.g., caliper and image log, if available). As an example, a MEM may be updated, calibrated, validated, etc., using one or more types of data that may be available at a wellsite, which can include real-time sensor data.

In various instances, uncertainty can exist for a MEM, particularly where laboratory test data are not available. As explained with respect to the example of FIG. 12, the MEM component 1244 may receive various types of data, which can include laboratory data (e.g., UCS, TXC (triaxial compression tests) and TWC (thick wall cylinder laboratory tests, etc.) to determine strength properties and onset of failure at different confinements and flow velocities. In the example of FIG. 12, at least a portion of the real-time time series data 1220 can be utilized to reduce uncertainties in the MEM component 1244. For example, such data can be indicative of failure risks with respect to pressure, flow, etc., such that the MEM component 1244 can more accurately generate output germane to well operation. As explained, such data can be utilized for one or more purposes. For example, some of the real-time time series data 1220 may be utilized for updating, calibrating, validating, etc., the MEM component 1244.

As to the solids management advisor component 1246, which may be a sand management advisor component, it can utilize the MEM component 1244 together with the component 1242 (e.g., as to hole diameter, grain size, etc.) for computations of CDDP. In such an example, the solids management advisor 1242 can be a geomechanical model that predicts formation failure due to variations in rock effective stress and rock strength at different conditions of reservoir pressure and downhole pressure (e.g., bottom hole pressure). Such a geomechanical model can be subjected to loading conditions (e.g., pressures) at a wellbore face (e.g., drawdown and build-up) where, for example, production/injection pressures can be measured with one or more downhole tools. Various phenomena may occur at a wellbore face, a near-wellbore region, etc., which may lead to an increased risk of solids production from a formation (see, e.g., the diagram 400 of FIG. 4).

As an example, the solids management advisor component 1246 can include features to: perform a preliminary solids failure risk analysis (e.g., taking into consideration current uncertainty sources in the MEM component 1244 such as, for example, UCS, tectonics, etc.); perform a solids stability analysis where a safe drawdown envelope (CDDP analysis) is calculated, which can aim to minimize and/or avoids sand failure and production; and real-time update of a physics-based critical drawdown model.

In the example of FIG. 12, the geomechanical model can output one or more CDDP values, which as explained, can be valuable information for operations. As explained, a geomechanical model can be updated and calibrated with real-time data where such calibration can involve adjusting one or more geomechanical variables and/or parameters to reduce uncertainties to increase accuracy of predictions. As explained with respect to the example of FIG. 12, an output can be a CDDP log that represents time-varying safe operations limits for production. As shown in FIG. 12, the solids management advisor 1246 can provide information with respect to bottom hole flowing pressure and reservoir pressure, which can include various regions where some regions may represent heightened risk of issues.

In various scenarios, pressure drawdown analysis data may be available. For example, consider data from analysis of pressure-transient behavior observed while a well is flowing. Such data may be supplemented if data from one or more pressure buildup tests are available. In such an approach, data from drawdown and data from buildup tests may be compared, analyzed, etc., for example, to characterize how downhole pressure (e.g., bottom hole pressure) may fluctuate with respect to changes in surface flow rate. As buildup tests demand intervention by shutting-in a well or reducing production, performing such a test can introduce non-productive time (NPT) and stop or reduce production. A buildup test involves observing a rise in well pressure as a function of time after a well is shut-in or after the production rate is reduced. Buildup pressures may be measured at or near the bottom of the hole.

As an example, a method may involve controlling equipment (see, e.g., FIG. 3, etc.) in a manner to reduce production for a period of time and acquiring data as to well pressure as a type of buildup test while production is reduced. For example, consider an automated controller that can operate according to a schedule, a trigger, etc., to reduce production. As explained, a controller may provide for control of a choke, which may act to reduce production and cause a change in well pressure. In such examples, a system may automatically generate and/or acquire buildup data that may be utilized in combination with drawdown data.

As an example, a ML model can learn well behaviors from time series data that can be for different operational conditions, which can include conditions associated with a change in one or more pieces of equipment. For example, consider a change in a position of a choke that causes a change in differential pressure (see, e.g., FIGS. 10 and 11), which may be a downhole pressure to wellhead pressure and/or a drawdown pressure as a difference between a reservoir pressure and a downhole flowing pressure (e.g., bottom hole flowing pressure). As an example, a controller can instruct equipment to make one or more changes to generate time series data that can be utilized for training, testing predictions, etc., of one or more ML models and/or that can be utilized for updating one or more physics-based models (see, e.g., FIG. 12). As an example, one or more ML models may learn how a well responds to control such that control instructions and/or timing thereof may be generated for mitigating risk of a predicted solids event. For example, the information 1250 can include a schedule of control instructions where well response to such control instructions has been modeled using one or more ML models, which may provide for well response predictions such that control instructions can have predictable results (e.g., within some level of confidence, etc.).

As explained, various types of sensors may be utilized to acquire data. As an example, a method can include making temporary wellbore measurements for identifying a solids source or sources. For example, a fiber optic cable can be utilized to acquire a Distributed Temperature Survey (DTS) and/or a Distributed Acoustic Survey (DAS). Where a well is equipped with an ESP, a Y-tool completion may be utilized to allow well accessibility. In such an example, a cable can be run in hole to a target depth to then acquire data across an entire covered section in a single run-in-hole.

As an example, data can be acquired at shut-in and/or during flowing conditions. As an example, temperature time lapse analysis can be performed using one or more cables where, for example, a temperature time lapse analysis can be utilized for leakage identification while acoustic data can be interpreted to detect solids production. As an example, a high resolution sand production tool (e.g., the SANDVIEW tool, Schlumberger Limited, Houston, Texas) can be included in a run, utilizing a fiber optic cable for more accurate sand detection (e.g., high resolution sand detection). As an example, PLT can be combined with one or more other techniques for a more comprehensive fluid and sand profile determination.

The SANDVIEW tool for downhole sand surveillance integrates a sensor with signal processing and an interpretation algorithm to enhance detection of sand entry points and determine production rates. The SANDVIEW tool can detect single particles (e.g., as small as approximately 0.1 mm in diameter) up to approximately 1,500 impacts per second, while being relatively immune to sensing challenges posed by background noise from tool motion and fluid and gas jetting. The SANDVIEW tool can be deployed on wireline or tractor conveyance for accessing a wide range of wellbore trajectories.

As an example, the system 1200 of FIG. 12 can be a data-model driven real-time control system. As explained, various types of equipment may be at a wellsite (e.g., a surface set up of a flowline choke, associated controllers at a wellpad, power generation equipment, etc.). As explained, a choke may be actuated where, for example, a system can include a flowline choke model. As an example, one or more sources of power can be available at a wellsite, which may include gas turbine sources, solar sources, battery sources, etc. As an example, one or more systems may receive power related data and provide for controls or other actions based on power supply, power availability, stored power, etc.

As an example, the system 1200 may provide for coordinated control at multiple wells. For example, consider electric pumps powered by a common source of energy, a common power generator, etc. and/or gas lift via gas from a common source, a number of wells, a common compressor, etc. In such examples, a resource may be limited and subject to optimization for multiple wells where such optimization can account for predictions of solids events, for example, to mitigate occurrence of one or more predicted solids events. In various instances, a mitigation action for one well may increase availability of a resource for utilization at one or more other wells. For example, if a gas lift injection rate (GLIR) is reduced at one well, lift gas may be available for increasing GLIR at one or more other wells. As to operation of an electric pump, a reduction in electrical power to one electric pump may provide for an increase in electrical power to one or more other electric pumps. As an example, multiple instances of the system 1200 may be provided for multiple wells where an overarching model provides for management of one or more resources that can be distributed to optimize production while accounting for solids event related constraints such as in one or more CDDP logs, etc. As the system 1200 can provide for a prediction as to an occurrence of a solids event in advance, time can be available for an overarching model to execute one or more distribution and/or optimization routines. In such an approach, production from a field of multiple wells may be improved.

As an example, a system, a method, etc., may utilize one or more machine learning features, which can be implemented using one or more machine learning models. As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as time series data. When provided with time series data, LSTMs take time and sequence into account such that an LSTM can include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, data processing, image classification, object detection, pose estimation, question answering, text classification, etc., on multiple platforms. As an example, the system 500 of FIG. 5 may utilize one or more features of the TFL framework.

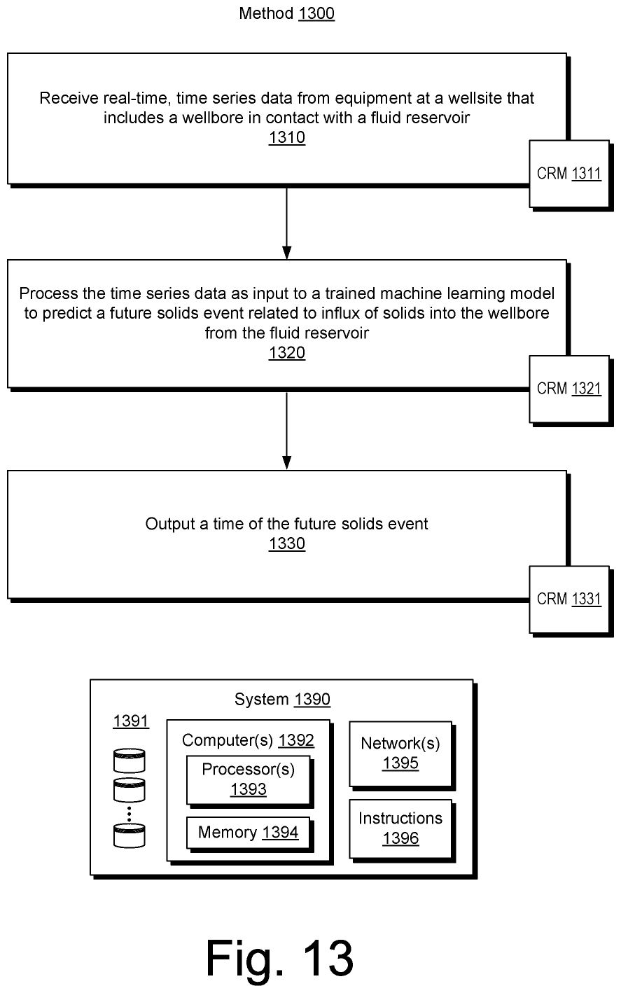

FIG. 13 shows an example of a method 1300 and an example of a system 1390. As shown, the method 1300 can include a reception block 1310 for receiving real-time, time series data from equipment at a wellsite that includes a wellbore in contact with a fluid reservoir; a process block 1320 for processing the time series data as input to a trained machine learning model to predict a future solids event related to influx of solids into the wellbore from the fluid reservoir; and an output block 1330 for outputting a time of the future solids event.

The method 1300 is shown in FIG. 13 in association with various computer-readable media (CRM) blocks 1311, 1321 and 1331. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1300. As an example, a computer-readable medium (CRM) may be a computer-readable storage medium that is non-transitory and that is not a carrier wave. As an example, one or more of the blocks 1311, 1321 and 1931 may be in the form of processor-executable instructions.

In the example of FIG. 13, the system 1390 includes one or more information storage devices 1391, one or more computers 1392, one or more networks 1395 and instructions 1396. As to the one or more computers 1392, each computer may include one or more processors (e.g., or processing cores) 1393 and memory 1394 for storing the instructions 1396, for example, executable by at least one of the one or more processors 1393 (see, e.g., the blocks 1311, 1321 and 1331). As an example, a computer may include one or more network interfaces (e.g., wired or wireless), one or more graphics cards, a display interface (e.g., wired or wireless), etc.

As an example, a method can include receiving real-time, time series data from equipment at a wellsite that includes a wellbore in contact with a fluid reservoir; processing the time series data as input to a trained machine learning model to predict a future solids event related to influx of solids into the wellbore from the fluid reservoir; and outputting a time of the future solids event. In such an example, the solids event can be or include a sand event related to influx of sand into the wellbore from the fluid reservoir.

As an example, a trained machine learning model can include a 1D convolution neural network. As an example, a trained machine learning model can include an encoder and a decoder, which can be components of an autoencoder. In such an example, a method can include comparing output of the decoder to input to the encoder where such comparing provides for making a prediction as to a future solids event. For example, consider a method that includes computing a root mean square error based on such comparing and then comparing the root mean square error to a threshold to predict the future solids event. In such an example, the output and the input may not match, which can be an indicator that the trained machine learning model cannot adequately generate suitable output because, for example, the trained machine learning model has not been trained on such input, which can be input associated with an anomaly that was not represented in training data during training of the machine learning model. As explained, an anomaly can be a solids event while normal operation can be free of such an anomaly (e.g., no solids event(s)). As an example, a trained machine learning model can be an anomaly detector where a solids event is considered to be a type of anomaly (e.g., abnormal behavior, etc.).

As an example, a method can include training a machine learning model. For example, consider training that includes utilizing controversial optimization that forces generation of output toward non-solids events and away from solids events and/or that includes utilizing training data from one or more wells for non-solids events. In such an approach, a trained machine learning model may be a poor generator of meaningful output when provided with data indicative of a solids event such that the output can be interpreted as being representative of abnormal behavior where normal behavior can be associated with non-solids events.

As an example, a method can include issuing a control instruction to at least one piece of equipment at a wellsite. In such an example, the at least one piece of equipment can include one or more of a valve, a pump and a gas supply to at least one gas lift valve. For example, consider a choke valve (e.g., downhole, surface, etc.), a gas valve, a sucker rod pump, a PCP, an ESP, a gas compressor, etc.

As an example, a method can include performing processing that includes utilizing a geomechanical model that models stability of reservoir rock of a fluid reservoir. In such an example, processing can include utilizing a mechanical earth model that models stresses based at least in part on reservoir rock properties. In such an example, a method can include updating the mechanical earth model using at least a portion of real-time, time series data.

As an example, a method can include outputting a log of critical drawdown pressure operational parameters for the well. In such an example, at least one of the critical drawdown operational parameters can depend on a time of a predicted future solids event. As an example, a method can include outputting a probability for a future solids event.

As an example, a system can include a processor; memory accessible to the processor; and processor-executable instructions stored in the memory to instruct the system to: receive real-time, time series data from equipment at a wellsite that includes a wellbore in contact with a fluid reservoir; process the time series data as input to a trained machine learning model to predict a future solids event related to influx of solids into the wellbore from the fluid reservoir; and output a time of the future solids event.

As an example, one or more computer-readable storage media can include processor-executable instructions to instruct a computing system to: receive real-time, time series data from equipment at a wellsite that includes a wellbore in contact with a fluid reservoir; process the time series data as input to a trained machine learning model to predict a future solids event related to influx of solids into the wellbore from the fluid reservoir; and output a time of the future solids event.

As an example, a computer program product can include one or more computer-readable storage media that can include processor-executable instructions to instruct a computing system to perform one or more methods and/or one or more portions of a method.

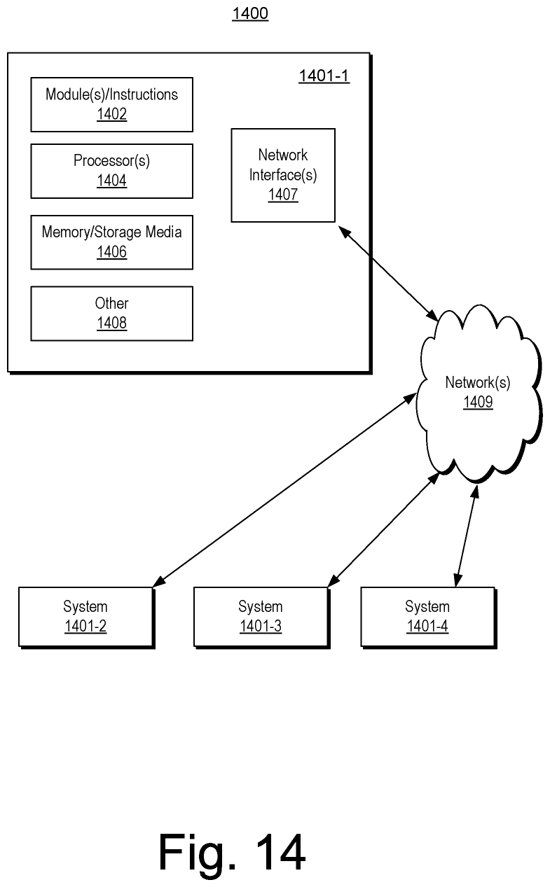

In some embodiments, a method or methods may be executed by a computing system. FIG. 14 shows an example of a system 1400 that can include one or more computing systems 1401-1, 1401-2, 1401-3 and 1401-4, which may be operatively coupled via one or more networks 1409, which may include wired and/or wireless networks.

As an example, a system can include an individual computer system or an arrangement of distributed computer systems. In the example of FIG. 14, the computer system 1401-1 can include one or more modules 1402, which may be or include processor-executable instructions, for example, executable to perform various tasks (e.g., receiving information, requesting information, processing information, simulation, outputting information, etc.).

As an example, a module may be executed independently, or in coordination with, one or more processors 1404, which is (or are) operatively coupled to one or more storage media 1406 (e.g., via wire, wirelessly, etc.). As an example, one or more of the one or more processors 1404 can be operatively coupled to at least one of the one or more network interfaces 1407. In such an example, the computer system 1401-1 can transmit and/or receive information, for example, via the one or more networks 1409 (e.g., consider one or more of the Internet, a private network, a cellular network, a satellite network, etc.).

As an example, the computer system 1401-1 may receive from and/or transmit information to one or more other devices, which may be or include, for example, one or more of the computer systems 1401-2, etc. A device may be located in a physical location that differs from that of the computer system 1401-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include general purpose processors or application specific chips (e.g., or chipsets), such as ASICs, FPGAs, PLDs, or other appropriate devices.

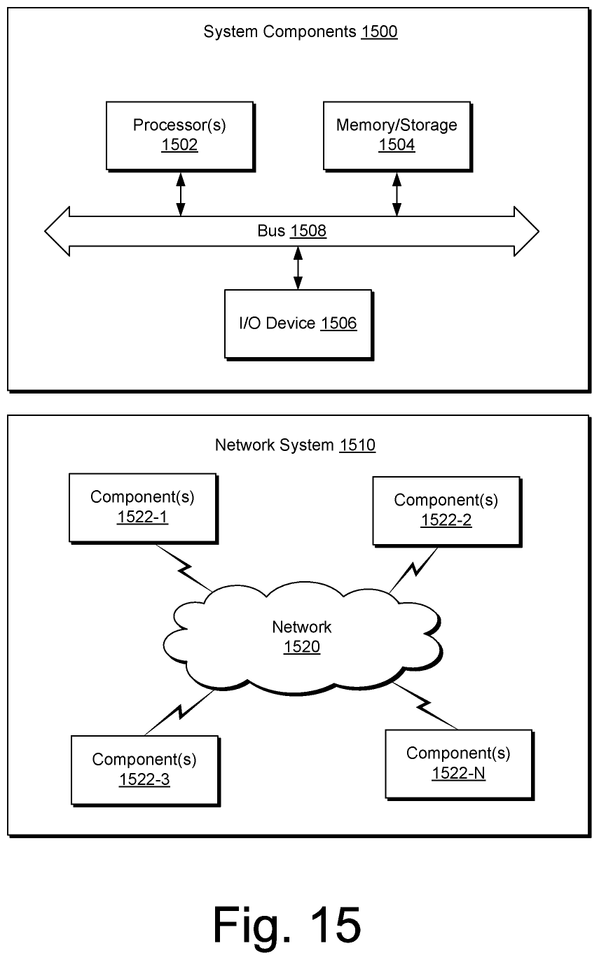

FIG. 15 shows components of an example of a computing system 1500 and an example of a networked system 1510 with a network 1520. The system 1500 includes one or more processors 1502, memory and/or storage components 1504, one or more input and/or output devices 1506 and a bus 1508. In an example embodiment, instructions may be stored in one or more computer-readable media (e.g., memory/storage components 1504). Such instructions may be read by one or more processors (e.g., the processor(s) 1502) via a communication bus (e.g., the bus 1508), which may be wired or wireless. The one or more processors may execute such instructions to implement (wholly or in part) one or more attributes (e.g., as part of a method). A user may view output from and interact with a process via an I/O device (e.g., the device 1506). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1510. The network system 1510 includes components 1522-1, 1522-2, 1522-3, . . . 1522-N. For example, the components 1522-1 may include the processor(s) 1502 while the component(s) 1522-3 may include memory accessible by the processor(s) 1502. Further, the component(s) 1522-2 may include an I/O device for display and optionally interaction with a method. The network 1520 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving real-time, time series data from equipment at a wellsite that comprises a wellbore in contact with a fluid reservoir;
processing the time series data as input to a trained machine learning model to predict a future solids event related to influx of solids into the wellbore from the fluid reservoir; and
outputting a time of the future solids event.

2. The method of claim 1, wherein the solids event comprises a sand event related to influx of sand into the wellbore from the fluid reservoir.

3. The method of claim 1, wherein the trained machine learning model comprises a 1D convolution neural network.

4. The method of claim 1, wherein the trained machine learning model comprises an encoder and a decoder.

5. The method of claim 4, wherein the encoder and the decoder are components of an autoencoder.

6. The method of claim 4, comprising comparing output of the decoder to the input to predict the future solids event.

7. The method of claim 6, comprising computing a root mean square error based on the comparing and comparing the root mean square error to a threshold to predict the future solids event.

8. The method of claim 1, comprising training the machine learning model.

9. The method of claim 8, wherein the training comprises utilizing controversial optimization that forces generation of output toward non-solids events and away from solids events.

10. The method of claim 8, wherein the training comprises utilizing training data from one or more wells for non-solids events.

11. The method of claim 1, comprising issuing a control instruction to at least one piece of equipment at the wellsite.

12. The method of claim 11, wherein the at least one piece of equipment comprises one or more of a valve, a pump and a gas supply to at least one gas lift valve.

13. The method of claim 1, wherein the processing comprises utilizing a geomechanical model that models stability of reservoir rock of the fluid reservoir.

14. The method of claim 13, wherein the processing comprises utilizing a mechanical earth model that models stresses based at least in part on reservoir rock properties.

15. The method of claim 13, comprising updating the mechanical earth model using at least a portion of the real-time, time series data.

16. The method of claim 1, wherein the outputting outputs a log of critical drawdown pressure operational parameters for the well.

17. The method of claim 16, wherein at least one of the critical drawdown operational parameters depends on the time of the future solids event.

18. The method of claim 1, wherein the outputting outputs a probability for the future solids event.

19. A system comprising:
a processor;
memory accessible to the processor; and
processor-executable instructions stored in the memory to instruct the system to:
receive real-time, time series data from equipment at a wellsite that comprises a wellbore in contact with a fluid reservoir;
process the time series data as input to a trained machine learning model to predict a future solids event related to influx of solids into the wellbore from the fluid reservoir; and
output a time of the future solids event.

20. One or more computer-readable storage media comprising processor-executable instructions to instruct a computing system to:
receive real-time, time series data from equipment at a wellsite that comprises a wellbore in contact with a fluid reservoir;
process the time series data as input to a trained machine learning model to predict a future solids event related to influx of solids into the wellbore from the fluid reservoir; and
output a time of the future solids event.
